(19) United States
(12) Patent Application Publication
(10) Pub. No.: US 2023/0160746 A1
(43) Pub. Date: May 25, 2023

(54) A SYSTEM AND METHOD FOR SHAPING A LIGHT SPECTRUM

(71) Applicant: Heriot-Watt University, Edinburgh (GB)

(72) Inventors: Marius RUTKAUSKAS, Edinburgh (GB); Derryck REID, Edinburgh (GB); Yoann ALTMANN, Edinburgh (GB)

(73) Assignee: Heriot-Watt University, Edinburgh (GB)

(21) Appl. No.: 17/920,864

(22) PCT Filed: Apr. 27, 2021
(86) PCT No.: PCT/GB2021/051011

§ 371 Date: Oct. 24, 2022

(30) Foreign Application Priority Data
May 8, 2020 (GB) 2006857.3

(51) Int. Cl. G01J 3/18; G01J 3/02

(52) U.S. Cl. CPC G01J 3/1809; G01J 3/0229

(57) ABSTRACT

An apparatus and a method for shaping a light spectrum are presented. The apparatus includes a spatial light modulator (140) provided for shaping the spectrum of a primary beam. The spatial light modulator (140) includes an array of cells in which each cell is operable in a first state and a second state. The apparatus also includes a controller (160) configured to change the state of a subset of cells iteratively, based on a stochastic process, to shape the spectrum.

### TECHNICAL FIELD

The present disclosure relates to a system and method for shaping a light spectrum. In particular, the disclosure relates to a system for shaping a broadband optical spectrum.

### BACKGROUND

The spectrum of a light source has an intensity that varies with the various wavelengths present in the light source. However, for some applications it may be desirable to use a particular intensity at a particular wavelength or ranges of wavelengths. To this end, various techniques have been proposed to shape the spectrum of a light source. A spatial light modulator, such as a digital micromirror device is often used to reject or maintain specific wavelength components of the original spectrum.

A digital micromirror device (DMD) includes a rectilinear array of mirrors which can be actuated individually to change their orientation and so control the angle at which light is returned from each mirror. The mirror dimensions are typically on the scale of several μm, and the total array may contain hundreds of thousands to few millions of micromirrors.

A dispersive optical element such as a grating or prism is used with some other imaging optics to project a line spectrum onto the mirror surface such that different constituent wavelengths in the light are localised over different regions of the DMD. Thus, the light on the DMD is spatially dispersed along one direction, and its wavelength is dispersed along the orthogonal direction. By actuating the DMD array with a specific pattern, some wavelengths are returned by the DMD and others are not, resulting in a spectrally shaped beam being achieved. U.S. Pat. No. 8,144,321(B2) describes a system using a DMD array used to apply a mask in order to encode light. However, obtaining the correct spectral mask to obtain a desired spectral shape presents some challenges. The light from a perfectly single-wavelength plane wave source does not illuminate only a single mirror on the DMD but is instead distributed (typically in a Gaussian distribution) over a 2D region of mirrors. Therefore, when considering a broadband light source, the question of what pattern to configure the DMD to obtain some desired spectral intensity does not have a simple answer because of the way the light is distributed spatially and spectrally across many mirrors.

Goldstein, et al., “DMD-based adaptive spectral imagers for hyperspectral imagery and direct detection of spectral signatures,” SPIE Proc. 721008 (2009) describes a method based on the concept of grayscale “super pixels” and matched filters. However this approach is only suitable for Hadamard spectroscopy, but with no direct shaping presented.

Rice et al., “A hyperspectral image projector for hyperspectral imagers,” Algorithms and Technologies for Multispectral, Hyperspectral, and Ultraspectral Imagery XIII, S. S. Shen and P. E. Lewis, eds. (SPIE, 2007), describes a method for attenuating spectral intensity by symmetrically turning off mirrors along the spatially dispersed direction, starting from the most intense pixel. A feedback is used to select the size of the attenuated region. This approach is limited in its dynamic range and has been demonstrated only for relatively smooth spectral shapes.

Luo et al., “Programmable light source based on an echellogram of a supercontinuum laser,” Applied Optics 56, 2359 (2017) describes a method based on least squares minimisation. This approach is not suitable for spectral shapes having edges such as square-shaped spectra, as it results in the presence of overshoot located at the edges.

Chuang et al., “Digital programmable light spectrum synthesis system using a digital micromirror device,” Appl. Opt. 45, 8308 (2006). This method requires a pre-calibration step approach by scanning the DMD. This pre-calibration must be repeated if the light source is changed.

It is an object of the disclosure to address one or more of the above mentioned limitations.

### SUMMARY

According to a first aspect of the disclosure, there is provided an apparatus for shaping a light spectrum, the apparatus comprising a spatial light modulator comprising an array of cells, each cell being operable in a first state and a second state, for shaping the spectrum of a primary beam, and a controller configured to change the state of a subset of cells iteratively, based on a stochastic process, to shape the spectrum.

For example, the first state may be a ON state configured to maintain an incoming ray in the beam, and the second state may be an OFF state configured to cancel or reject an incoming ray from the beam.

Optionally, the apparatus comprises a dispersive element adapted to produce the primary beam, an optical device arranged to image the primary beam onto the spatial light modulator to produce a secondary beam having a shaped spectrum, a detector adapted to measure the shaped spectrum, wherein the controller is configured to perform a sequence of steps comprising: calculating a difference between the shaped spectrum and a target spectrum to obtain a difference spectrum having a plurality of spectral elements, each spectral element being associated with a corresponding set of cells in the array, calculating an error value and generating a list of random values for each set of cells, changing a state of one or more cells selected based on the list of random values; and repeating iteratively the sequence of steps to reduce the error values.

Each random value may vary between a minimum and a maximum. For instance, each random value may vary between 0 and a value less than 1. The sequence of steps may be repeated until each error value corresponding to each set of cells is less than an absolute threshold value.

Optionally, each random value is assigned to a corresponding cell or group of cells.

Optionally, each cell is operable in one or more additional states. For example, each cell may be operable in a third state and a fourth state.

Optionally, the sequence comprises changing the configuration of the array by setting a plurality of cells in the second state when the error value is positive and by setting at least one cell in the first state when the error value is negative.

Optionally, the second state is associated with a first logic value and the first state is associated with a second logic value. For instance, the first logic value may be a logic 0 and the second logic value may be a logic 1.

Optionally, the controller is configured to generate for each set of cells a corresponding set of intermediate logic values, and to calculate an adjusted set of logic values for adjusting the state of the cells.

Optionally, the adjusted set of logic values is obtained by performing a logic operation between the set of intermediate logic values and a previous set of logic values.

Optionally, when the error value is positive the controller is configured to compare each random value with the error value to generate the set of intermediate logic values, and to perform an AND logic operation between the set of intermediate logic values and a corresponding previous set of logic values to obtain the adjusted set of logic values.

Optionally, when the error value is negative the controller is configured to generate the set of intermediate logic values by calculating a product based on the random value and the error value, and to perform an OR logic operation between the set of intermediate logic values and a corresponding previous set of logic values to obtain the adjusted set of logic values.

Optionally, the controller is adapted to set the spatial light modulator to an initial configuration before starting the sequence, wherein the initial configuration is based on a profile of the target spectrum.

For instance, in the initial configuration, the sets of cells corresponding to a spectral window of the target spectrum having a zero intensity may be set to the second state, while the sets of cells corresponding to a spectral window of the target spectrum having a non-zero intensity may be set to the first state. Alternatively, the initial configuration may be a pre-determined configuration known to result in the desired target spectrum or a target shape that is similar to the desired target spectrum.

Optionally, the dispersive element, the optical device, the spatial light modulator and the detector are provided along an optical path, the spatial light modulator being arranged such that the secondary beam is reflected back along the optical path towards the detector.

Optionally, the apparatus comprises an additional dispersive element and an additional optical device wherein the dispersive element, the optical device, and the spatial light modulator are provided along a first optical path, and wherein the additional dispersive element, the additional optical device and the detector are provided along a second optical path, the spatial light modulator being arranged such that the secondary beam is reflected along the second optical path towards the detector.

Optionally, the apparatus comprises an echelle grating coupled to the dispersive element to generate a plurality of dispersed beams each beam having a corresponding spectrum forming an echellogram, and wherein the controller is configured to shape the echellogram.

Optionally, each spectrum forming the echellogram is shaped to match a corresponding target spectrum.

Optionally, the controller is configured to assign different regions of the array to a specific spectrum of the echellogram, and to control the cells of each region to shape a corresponding spectrum.

Optionally, the optical device is adapted to project the spectrum onto the spatial light modulator to obtain a projected spectrum having a circular or semi-circular shape. For instance, the optical device may comprise a cylindrical lens.

Optionally, the cells are mirror cells, each mirror cell being individually orientable to be configured in the first state or the second state. For instance, the spatial light modulator may be a digital micromirror device comprising an array of mirror cells, each mirror cell being operable in a first mirror orientation corresponding to the first state and a second mirror orientation corresponding to the second state.

Optionally, the cells are polarizing cells. For instance, the spatial light modulator may be a liquid crystal device comprising an array of liquid crystal cells, the polarization of each cell being controllable to set the cell in the first state or the second state.

According to a second aspect of the disclosure, there is provided a system comprising an apparatus according to the first aspect coupled to a light source.

Optionally, the light source comprises at least one of a laser source, a thermal emitter, a fluorescence source and an amplified spontaneous emission source. For instance, the laser source may be a broadband laser source; and the thermal emitter may be a broadband thermal emitter.

Optionally, the laser source comprises at least one of an ultrafast laser, an ultrafast optical parametric oscillator, and a laser supercontinuum.

The system according to the second aspect of the disclosure may comprise any of the features described above in relation to the apparatus according to the first aspect of the disclosure.

According to a third aspect of the disclosure, there is provided a method for shaping a light spectrum, the method comprising providing a spatial light modulator having an array of cells, each cell being operable in a first state and a second state, for shaping the spectrum of a primary beam, and changing the state of a subset of cells iteratively, based on a stochastic process, to shape the spectrum.

Optionally, the method comprises imaging the primary beam onto the spatial light modulator to produce a secondary beam having a shaped spectrum, and performing a sequence of steps comprising: calculating a difference between the shaped spectrum and a target spectrum to obtain a difference spectrum having a plurality of spectral elements, each spectral element being associated with a corresponding set of cells in the array; calculating an error value and generating a list of random values for each set of cells, changing a state of one or more cells selected based on the list of random values; and repeating iteratively the sequence of steps to reduce the error values.

The third aspect may share features of the first and second aspects, as noted above and herein.

### DESCRIPTION

The disclosure is described in further detail below by way of example and with reference to the accompanying figures, in which:

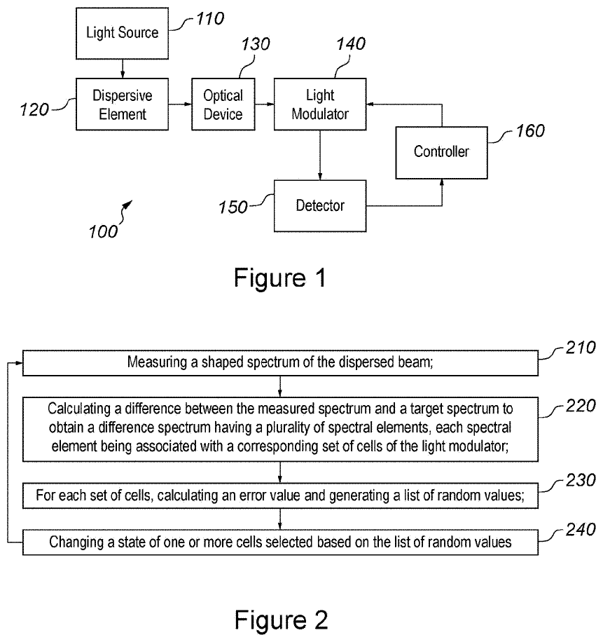

FIG. 1 is a schematic diagram of an optical system for shaping a light spectrum according to the disclosure;

FIG. 2 is a flow diagram of a method for shaping a light spectrum using the system of FIG. 1;

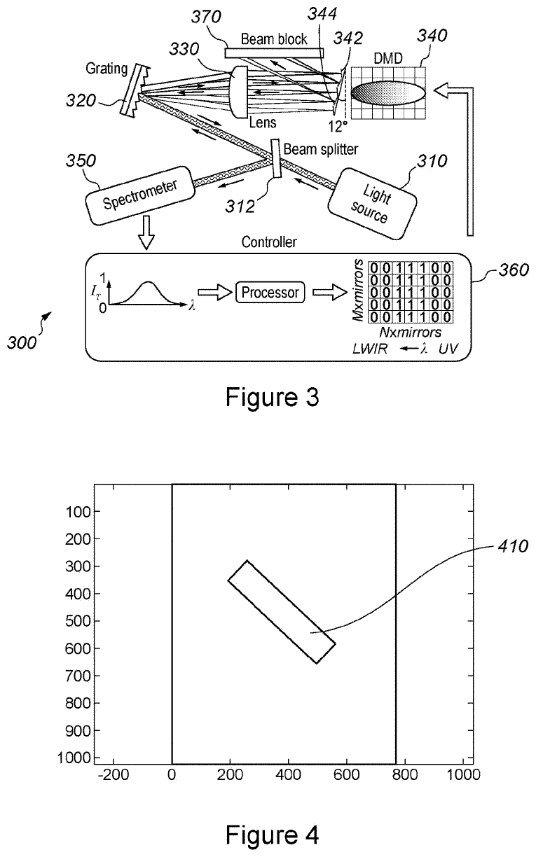

FIG. 3 is an implementation of the system of FIG. 1;

FIG. 4 is a map of a digital micromirror device (DMD) showing the location of the dispersed light projected on its surface;

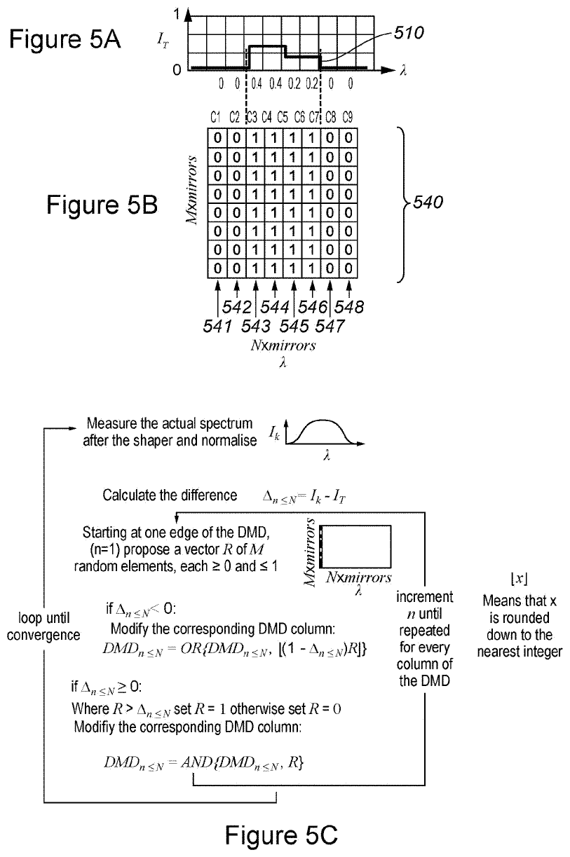

FIG. 5A is an exemplary target spectrum;

FIG. 5B is a matrix of logic values showing an initial DMD pattern;

FIG. 5C is a diagram illustrating a method for adjusting the DMD pattern iteratively;

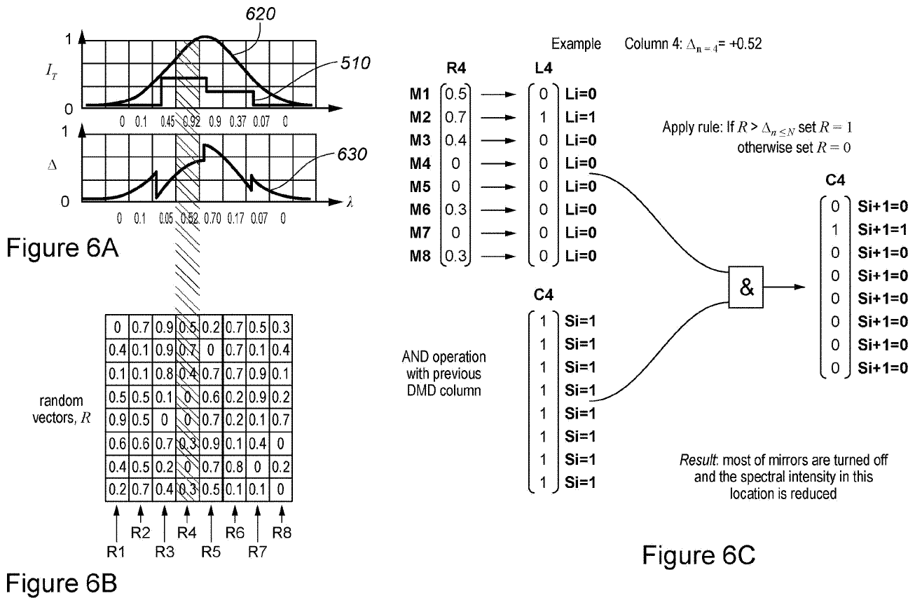

FIG. 6A is a plot illustrating a target spectrum, a measured spectrum and a difference spectrum obtained using the system of the disclosure;

FIG. 6B is a random matrix made of random values associated with the mirrors of the DMD of FIG. 5;

FIG. 6C is a calculation for obtaining the adjusted mirror states when an error value is positive;

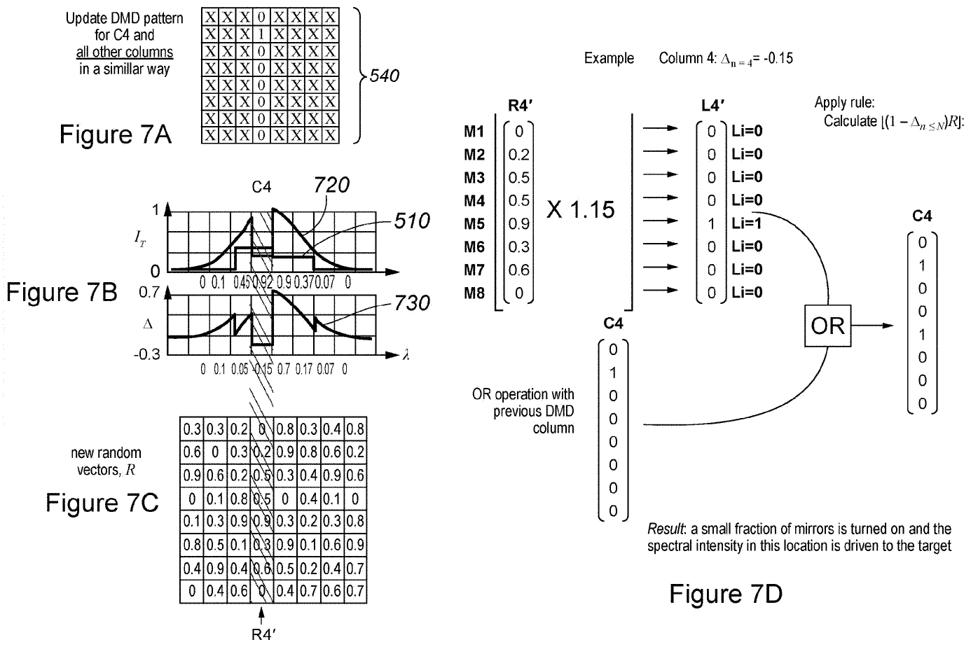

FIG. 7A is a matrix illustrating the logic values calculated in FIG. 6C;

FIG. 7B is a plot illustrating the target spectrum, the measured spectrum and a difference spectrum obtained after a change in DMD pattern according to FIG. 6;

FIG. 7C is another random matrix of random values;

FIG. 7D is a calculation for obtaining the adjusted mirror states when an error value is negative;

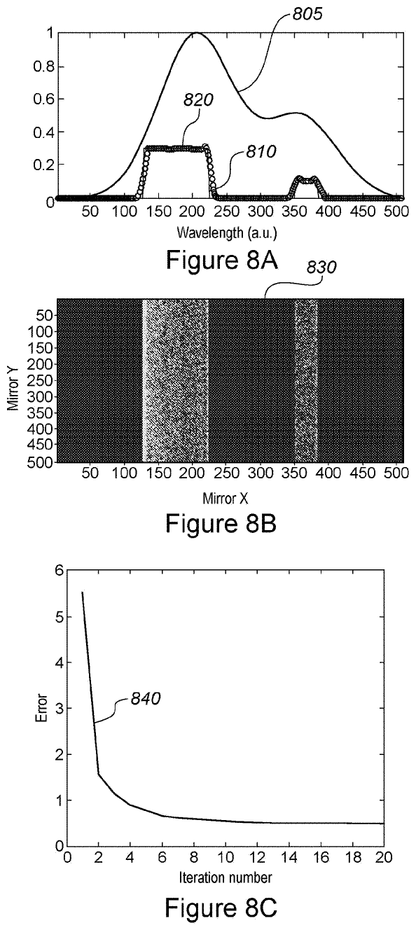

FIG. 8A is a plot illustrating a shaped spectrum using the method according to the disclosure after 20 iterations;

FIG. 8B is a mirror state map showing the DMD pattern used in FIG. 8A;

FIG. 8C is a plot illustrating a difference between the shaped spectrum and the target spectrum as a function of time using the method of the disclosure;

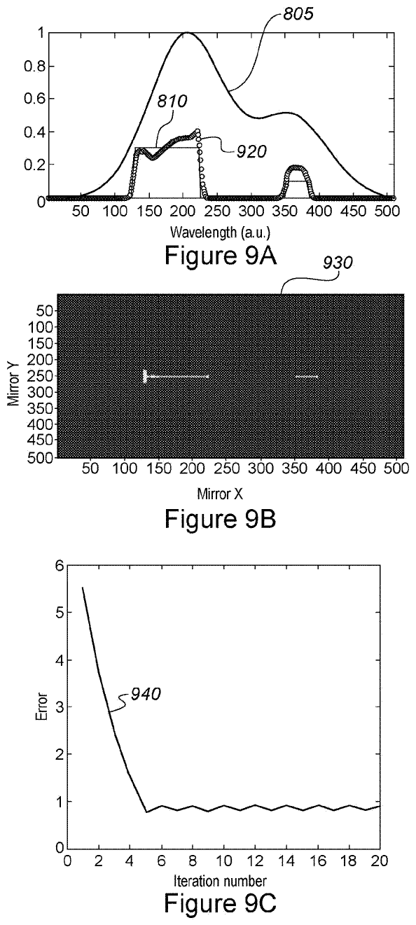

FIG. 9A is a plot illustrating a shaped spectrum using a prior art method;

FIG. 9B is a mirror state map showing the DMD pattern used in FIG. 9A;

FIG. 9C is a plot illustrating a difference between the shaped spectrum and the target spectrum as a function of time using the prior art method;

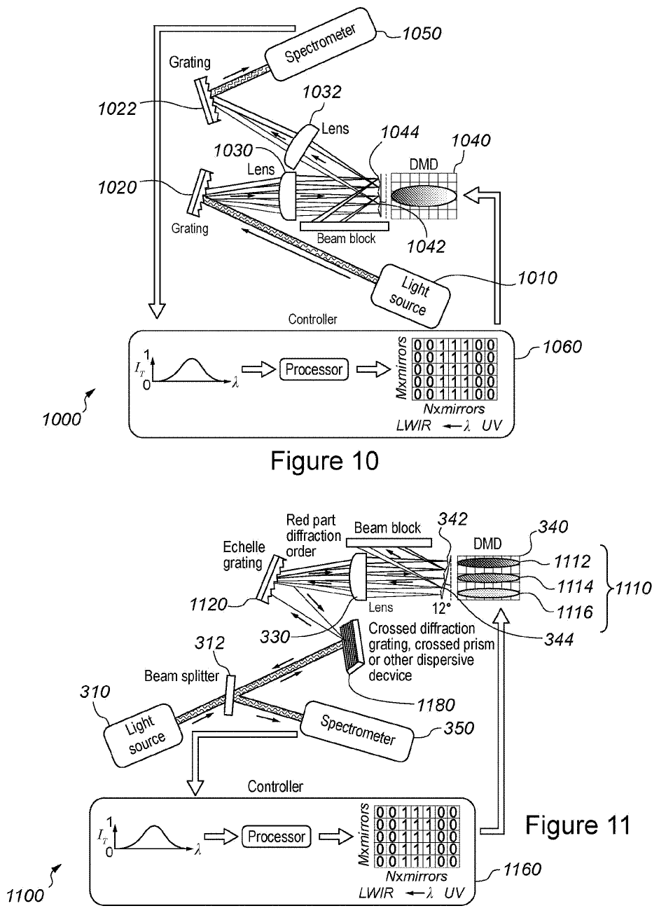

FIG. 10 is another implementation of the system of FIG. 1;

FIG. 11 is a system designed to shape several light spectra in parallel;

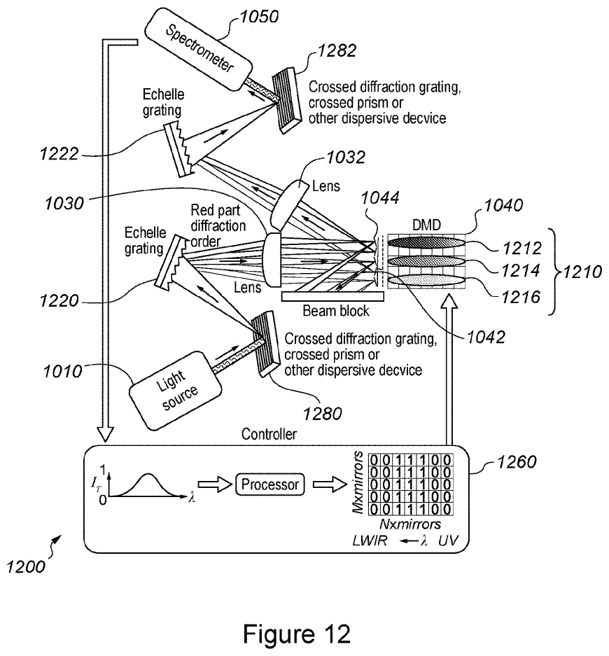

FIG. 12 is another system designed to shape several light spectra in parallel;

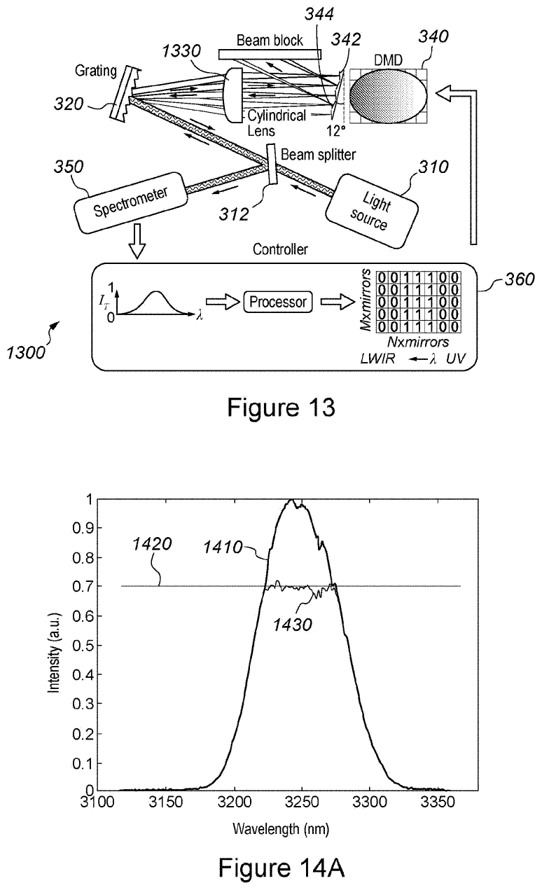

FIG. 13 is a diagram illustrating a modified version of the system of FIG. 3;

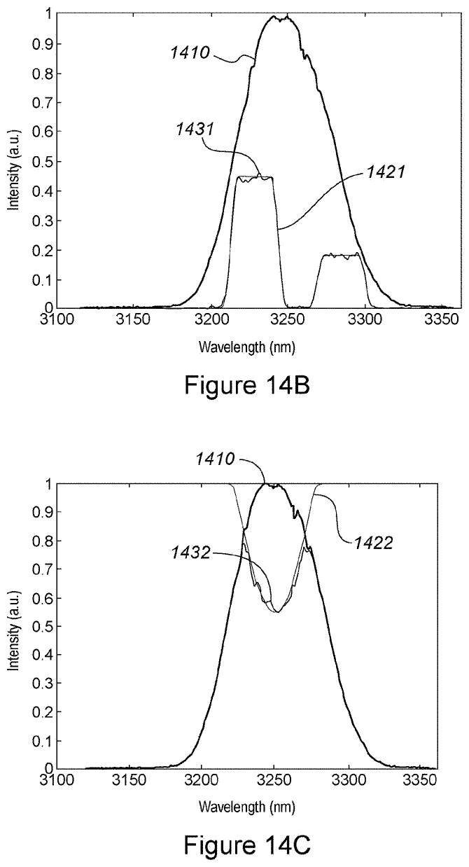

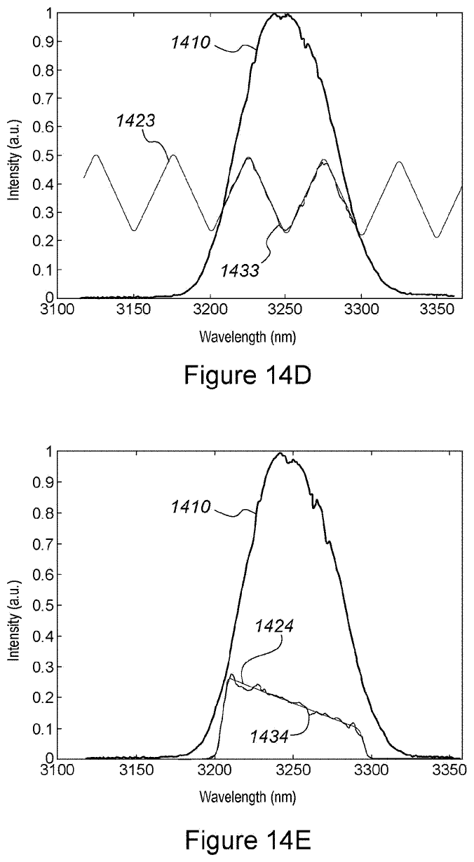

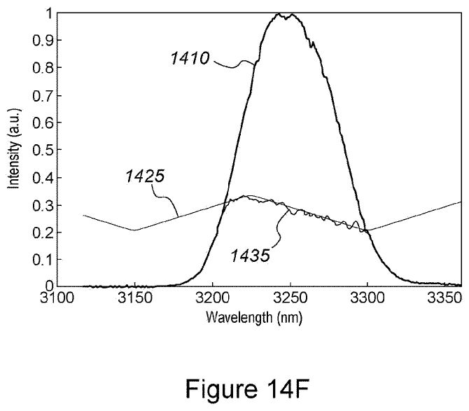

FIGS. 14A to 14F are the measurements of six light spectra shaped using the method according the disclosure to match different target profiles.

FIG. 1 illustrates an optical system 100 provided with a light source 110 coupled to an apparatus for shaping a light spectrum. The apparatus includes a dispersive element 120, an optical device 130, a light modulator 140, a detector 150 and a controller 160.

The light source 110 may be a polychromatic source of electromagnetic radiation. Different light sources may be selected depending on the application. For instance, the light source 110 may be a laser source, a thermal emitter, a fluorescence source or an amplified spontaneous emission source. A laser source may include an ultrafast laser, an ultrafast optical parametric oscillator, or a laser supercontinuum. Other light sources providing a broadband spectrum, or a band-limited spectrum may also be used. The dispersive element 120 may include a grating or a prism or other types of dispersive elements for dispersing the wavelengths of an incoming beam. The optical device 130 may be provided by one or more imaging optical elements. For instance, the optical device 130 may be a lens or a combination of lenses, or a collimator. The optical device 130 is positioned between the dispersive element 120 and the light modulator 140 to image the dispersed beam onto the light modulator. The light modulator 140, also referred to as spatial light modulator comprises an array of cells. Each cell is operable in at least two states: a first state also referred to as an ON state and a second state, also referred to as an OFF state. For instance, the spatial light modulator 140 may be a digital micromirror device (DMD) provided with a 2D array of mirror cells also referred to as micromirrors. Alternatively, the spatial light modulator may be a liquid crystal device such as a liquid crystal on silicon (LCOS) provided with a 2D array of polarizing cells. The detector 150 is adapted to measure the spectrum of the beam reflected by the light modulator. For instance, the detector 150 may be a spectrometer to measure the intensity of the wavelength bands forming the spectrum of the reflected beam. The controller 160 may include a memory to store a list of pre-determined target spectra, and a processor configured to perform a sequence of processing steps for controlling the cells of the light modulator 140. Various implementations of the system 100 can be envisaged as described with respect to FIGS. 3, 10, 11 and 12.

In operation the controller 160 is configured to change the orientation of the cells iteratively, based on a stochastic process, to shape the spectrum. The dispersive element 120 receives an input beam from the light source 110 to produce a primary dispersed beam. The primary dispersed beam is then imaged by the optical device 130 onto the light modulator 140 to produce a secondary dispersed beam having a shaped spectrum. The detector 150 measures the shaped spectrum and sends it to the controller 160. Depending on the design of the system, the light reflected by the light modulator may be directed toward the detector 150 via different optical paths. The controller 160 then compares the shaped spectrum with a target spectrum and generates one or more feedback signals to change the configuration of the light modulator 140 by changing the state of one or more cells in the array. The method performed by the controller 160 is described further in FIG. 2.

FIG. 2 illustrates a flow chart of a method for shaping a spectrum using the system of FIG. 1. At step 210, the detector 150 measures the shaped spectrum of the secondary beam reflected by the light modulator 140. At step 220 the controller 160 receives the measured shaped spectrum and calculates a difference between the shaped spectrum and a target spectrum to obtain a difference spectrum. The target spectrum may be selected from a list of pre-set or pre-determined target spectra. Alternatively, the target spectrum may be set by a user of the system. The difference spectrum has a plurality of spectral elements associated with a specific set of cells in the array of the light modulator 140. Each spectral element may be a single wavelength or a range of wavelengths. At step 230, the controller 160 calculates an error value and generates a list of random values for each set of cells. So a matrix of random value is generated with each random value being assigned to a specific cell or to a specific group of cells in the array. Each list of random values may be referred to as a random vector. At step 240, the controller 160 adjusts a configuration of the light modulator 140 by changing the state of one or more cells selected based on the list of random values. The detector 150 then measures the newly shaped spectrum and the sequence of steps 210 to 240 is repeated iteratively to reduce the error values. For instance, the sequence of steps may be repeated until each error value corresponding to each set of cells is less than an absolute threshold value. The threshold value may be a pre-determined value or a value set by the user depending on the application.

By changing the configuration of the light modulator 140 based at least in part, on a stochastic process, the system can create relatively small changes of intensity of the spectral components forming the spectrum. As a result the spectrum can be shaped with a high degree of accuracy. Using the system and method of the disclosure, a light spectrum can be also shaped rapidly, only requiring a few iteration to converge towards the desired spectral profile.

The proposed approach presents several other advantages over the prior art systems mentioned in the background section. The proposed approach is not based on Fourier Transform analysis, and therefore is not altered by overshot artefacts that may arise due to Fourier synthesis of the DMD pattern. Since the light modulator does not require pre-calibration, the spectral shaper can adapt automatically if the source spectrum changes. In addition the shaping resolution is only limited by the spatio-spectral point-spread function of the light modulator.

The technique can be applied across the entire optical spectrum, from the UV to IR, for instance between about 1 nm to about 1 mm. Depending on the application subranges may be selected for instance from about 200 nm to about 20 μm. Shaped spectra in the mid-infrared region may be used for chemical imaging and detection, for example using techniques such as compressive sensing. Other applications may include the control of photosensitive reactions.

FIG. 3 illustrates an example implementation of the optical system of FIG. 1. The system 300 includes a light source 310, a diffraction grating 320, a lens 330, a digital micromirror device (DMD) 340, a spectrometer 350, and a controller 360. The light source 310, the diffraction grating 320, the lens 330, and the digital micromirror device (DMD) 340 are optically aligned such that a primary beam from the light source 310 is diffracted by the grating 320 and imaged by the lens 330 onto the surface of the DMD 340. A beam splitter 312 is provided on the path of the light source 310 to deflect light returning from the DMD onto the spectrometer 350.

The light source 310 may be provided by a broadband mid-infrared light source. In this example the light source includes an optical parametric oscillator, OPO, providing light from 3200-3400 nm. The DMD includes a two-dimensional array of mirrors which can be actuated individually to change their orientation, hence allowing controller 360 to control the angle at which light is returned or deflected from each mirror. The mirror dimensions are typically on the scale of several μm, and the total array may contain between hundreds of thousands up to few millions of micromirrors.

In operation the grating 320 receives the input beam from the light source 310 and disperses the light into its constituent wavelengths to produce a primary dispersed beam comprising multiple rays having different wavelengths. The primary beam passes through the lens 330 to be imaged onto the DMD 340. The grating 320 and the lens 330 are used to project a spectrum onto the mirror surface of the DMD 340 such that different constituent wavelengths in the beam are localised over different regions of the DMD. The beam is spatially dispersed along a first axis of the DMD and the wavelength constituents of the beam are dispersed along a second axis of the DMD, orthogonal to the first axis. By actuating the DMD array with a specific pattern, some wavelength constituents are deflected in order to be rejected from the spectrum while other constituents are reflected in order to be maintained in the spectrum, hence resulting in a spectrally shaped beam. Each mirror is operable in two states: a first state, referred to as ON state, corresponding to a first mirror orientation and a second state, referred to as OFF state, corresponding to a second mirror orientation. The dispersed beam propagates along an optical path defined by a propagation axis. In the embodiment of FIG. 3, the DMD is positioned such that the surface of the array of micromirrors is oriented at a specific angle with respect to an axis substantially perpendicular to the propagation axis. The specific angle is chosen so that each micromirror in the array is either in the ON state or in the OFF state.

In FIG. 3 the DMD has its surface oriented at a blaze angle of 12° with respect to the vertical axis. The micromirror 342 is in the ON state and its surface is substantially normal to the propagation axis. In contrast the micromirror 344 is in the OFF state and its surface is at an acute angle (in this example 24°) with respect to the propagation axis. As a result, the rays of the dispersed beam projected on the mirrors in the OFF state (rejection position) are deflected towards the beam blocker 370, while the rays projected on the mirrors in the ON state (reflection position) are reflected back along the propagation axis towards the diffraction grating 320. The beam splitter 312 is positioned such that the returning rays are sent toward the spectrometer 350. The spectrometer 350 is adapted to measure the shaped spectrum in real-time. The controller 360 receives the shaped spectrum and generates a feedback signal to change the orientation pattern of the micromirror of the DMD. In an alternative embodiment, the diffraction grating 320 may be replaced by another dispersive element such as a volume Bragg grating, a prism, a grating prism (grism), a photonic crystal or other refractive device. The DMD may also be rotated in order to facilitate the alignment of the various components of the system.

FIG. 4 represents the surface of a rectangular DMD. The region 410 shows the approximate location of the dispersed light on the DMD surface when the DMD is rotated by 45 degrees. By rotating the DMD by 45° to the vertical, the rotation axis of each micromirror may be positioned to be orthogonal to the plane containing the incident beam direction and the dispersion direction of the grating.

FIGS. 5, 6 and 7 provide an example implementation of the method illustrated in FIG. 2. FIGS. 5A and 5B show an exemplary target spectrum and an exemplary DMD mirror array, respectively. The target spectrum 510 has a normalised intensity I_{T} that varies as a function of the wavelength. In this example the target spectrum has a double step like profile.

For the purpose of this example, the DMD mirror array 540 is provided with a small number of mirrors, in this case an array of 8×8 mirrors forming 8 sets or columns C1 to C8 labelled 541 to 548. Each column is associated with a corresponding spectral window. At the start, the DMD may be set with an initial configuration, also referred to as initial DMD pattern based on the profile of the target spectrum. In this example the sets of mirrors 541, 542, 547 and 548 corresponding to spectral windows having a zero intensity in the target spectrum are set to the OFF state, while the sets of mirrors 543, 544, 545 and 546 corresponding to spectral windows having a non-zero intensity are set to the ON state. The OFF state is associated with a first logic value, for instance a logic low (Sᵢ=0) and the ON state is associated with a second logic value, for instance a logic high (Sᵢ=1).

FIG. 5C is a diagram illustrating how the DMD pattern may be adjusted iteratively. The spectrum I_{K} of the beam reflected by the DMD is measured and normalised. Then a difference also referred to as error value Δ_{n≤N}=Iₖ−I_{T} is calculated for each column (n) in the array of the DMD, in which n corresponds to a specific column in the array.

For each set of mirrors in a column, a corresponding vector R of random values M is provided. Each random value M in the vector R may vary between a minimum and a maximum value, for instance between 0 and less than 1.

The configuration of the array is then changed by setting a plurality of mirrors in the OFF state when the error value Δ_{n≤N} is positive and by setting at least one mirror in the ON state when the difference value Δ_{n≤N} is negative. This is achieved using the plurality of vectors R as follows.

For each set of mirrors or columns, the controller generates a corresponding set L of intermediate logic values Li, L(Li) and calculates an adjusted set C of logic values Si+1, C (Si+1) for adjusting the state of the mirrors. The adjusted set of logic values C(Si+1) is obtained by performing a logic operation between the set of intermediate logic values and a previous set of logic values.

When Δ_{n≤N}≥0, the controller compares each random value M with the error value Δ_{n≤N} to generate the set L of intermediate logic values. Each random value M in the vector R is compared with the error value to generate an intermediate logic value Li. If the random value M is greater than the error value M>Δ_{n≤N}, then Lᵢ=1 otherwise Lᵢ=0. The controller then performs an AND logic operation between the set of intermediate logic values L(Li) and a corresponding previous set of logic values C(Si) to obtain the adjusted set of logic values C(Si+1). Each new Sᵢ₊₁ logic value can then be used to set the corresponding mirror to the ON state (Sᵢ₊₁=1) or the OFF state (Sᵢ₊₁=0).

When Δ_{n≤N}<0, the controller generates the set of intermediate logic values L(Li) by calculating a product based on the random value and the error value. Each intermediate value Lᵢ is calculated based on the random value and the error value as Lᵢ=(1−Δ_{n≤N})R rounded down to the nearest integer (i.e. either 0 when Li<1, or 1 when Li≥1, since always Δ_{n≤N}≤1). The controller then performs an OR logic operation between the set of intermediate logic values L(Li) and a corresponding previous set of logic values C(Si) to obtain the adjusted set of logic values C(Si+1). Each new Sᵢ₊₁ logic value can then be used to set the corresponding mirror to the ON state (Sᵢ₊₁=1) or the OFF state (Sᵢ₊₁=0).

FIG. 6 illustrates a numerical example for the situation when the error value is positive and the DMD mirror has been initialized with a pattern containing columns of ones at wavelengths where the target spectrum has non-zero intensity. FIG. 6A shows the target spectrum 510, the measured spectrum 620 and the difference spectrum 630. FIG. 6B illustrates a random matrix made of 8 vectors R1-R8 of random values. FIG. 6C shows the calculation performed to obtain the new adjusted set of values based on vector R4. The error value for the fourth column is n=4=0.52. The eight random values M1-M8 of the vector R4 are compared with Δₙ₌₄=0.52 to obtain the intermediate set L4 of eight intermediate logic values Lᵢ. If M>Δₙ₌₄ then Lᵢ=1 otherwise Lᵢ=0. A AND logic operation is then performed between L4(Lᵢ) and C4(Sᵢ) to obtain a new list of Sᵢ₊₁ logic values for the column C4(Sᵢ₊₁). In this example most of the mirrors in column C4 are turned off (Logic 0) while only one mirror remains turned on (Logic 1). The spectral intensity in this location of the light modulator is therefore reduced.

FIG. 7 illustrates a numerical example for the situation when the error value is negative. FIG. 7A shows the DMD mirror array 540 having a new pattern illustrated for column C4. FIG. 7B shows the target spectrum 510, the measured spectrum 720 and the difference spectrum 730. FIG. 7C illustrates a new random matrix made of 8 vectors R1′-R8′ of random values. FIG. 7D shows the calculation performed to obtain the new adjusted set of values based on the vector R4′.

An intermediate set L4′ of eight intermediate logic values Lᵢ is calculated based on the random vector R4′ and the error value Δₙ₌₄=−0.15 as L4′=(1−Δₙ₌₄)R4′ rounded down to the nearest integer. For example (1−(−0.15))M5=1.035 which is rounded down to 1, and (1−(−0.15))M7=0.069 which is rounded down to 0. An OR logic operation is then performed between L4′(Lᵢ) and C4(Sᵢ) to obtain a new list of Sᵢ₊₁ logic values for the column C4(Sᵢ₊₁). In this example two mirrors are turned on (Logic 1), that is only one extra mirror compared with the previous iteration while the other mirrors remain turned off. The spectral intensity in this location increases towards the target value.

FIGS. 8 and 9 show the shaped spectra obtained by simulation using the method of the disclosure and using a method according to the prior art, respectively. In both cases the point-spread function is a Gaussian PSF occupying a 25×25 grid.

FIG. 8A shows the spectrum 805 of the input beam provided by the light source, the target spectrum 810 and the shaped spectrum 820 obtained using the method according to the disclosure after 20 iterations. FIG. 8B is a mirror state map 830 showing the DMD pattern obtained after 20 iterations and used to change the configuration of the mirrors to obtain the desired spectrum. FIG. 8C shows the error value (difference between shaped spectrum are target spectrum) as a function of the number of iterations.

FIG. 9A shows the spectrum 805 of the input beam provided by the light source, the target spectrum 810 and the shaped spectrum 920 obtained using a prior art method according to Rice et al., “A hyperspectral image projector for hyperspectral imagers,” (SPIE, 2007). FIG. 9B is a mirror state map 930 showing the DMD pattern obtained after 20 iterations. FIG. 9C shows the error value as a function of the number of iterations.

The random modulation approach can provide higher precision in the intensity shaping compared with techniques that constrain that the most intense pixels of the light modulator be switched off first. Using an algorithm in which the most intense mirrors are switched off in priority (FIG. 9), it can be observed that after 20 iterations the shaped spectrum 920 has not converged to the target spectrum. FIG. 9C shows that after 6 iterations the error oscillates in a flip-flop type behaviour indicating a poor convergence towards the target spectrum. In contrast the shaped spectrum 820 is very close to the desired target 810. FIG. 8C shows that after 4 iterations the error is lower than using the method of the prior art and keeps decreasing.

FIG. 10 illustrates another implementation of the system of FIG. 1. The system 1000 includes a light source 1010, two diffraction gratings 1020, 1022, two lenses 1030, 1032, a digital micromirror device DMD 1040, a spectrometer 1050, and a controller 1060. The light source 1010, the first diffraction grating 1020, the first lens 1030, and the digital micromirror device DMD 1040 are provided along a first optical path, such that a primary beam from the light source 1010 is diffracted by the grating 1020 along a primary propagation axis and imaged by the lens 1030 onto the surface of the DMD 1040. The second lens 1032, the second diffraction grating 1022 and the spectrometer 1050 are provided along a second optical path, such that a beam reflected from the surface of the DMD 1040 is focused by the lens 1032 onto the diffraction grating 1022 and sent onto the spectrometer 1050.

The DMD 1040 is positioned so the surface of the array of mirrors with is substantially orthogonal to the primary propagation axis. The micromirror 1042 is in the ON state and its surface is at a first angle allowing to reflect an incoming ray along the second propagation axis towards the spectrometer 1050. In contrast the micromirror 1044 is in the OFF state and its surface is at a second angle allowing to reflect an incoming ray along a third axis towards a beam block.

The controller 1060 receives the shaped spectrum from the spectrometer 1050 and generates a feedback signal to change the orientation pattern of the micromirror of the DMD 1040 as described above with respect to FIGS. 2, 5, 6 and 7. In an alternative embodiment, the first and second diffraction gratings 1020, 1022 may be replaced by a first dispersive element and a second dispersive element respectively. Example of suitable dispersive elements include volume Bragg gratings, prisms, grating prisms (grism), photonic crystals or other refractive devices.

Although the system of FIG. 10 requires more components than the system of FIG. 3, it is easier to align. In addition, as there is no need to split the input beam, a more intense beam can be imaged onto the light modulator. Furthermore, since the light modulator is provided at a right angle with respect to the propagation axis, all the wavelengths may be focused on a same plane of the light modulator.

FIG. 11 illustrates a modification of the system of FIG. 3 allowing to shape several spectra in parallel. FIG. 11 shares many similar components to those illustrated in FIG. 3. The same reference numerals have been used to represent corresponding components and their description will not be repeated for sake of brevity. In the system 1100, the diffraction grating 320 has been replaced by a first dispersive element 1180 optically arranged with a second dispersive element 1120. The first dispersive element 1180 may be a grating, a prism, a volume Bragg grating, a grating prism (grism), a photonic crystal or other refractive device, while the second dispersive element 1120 is provided by an echelle grating. The first and second dispersive elements are mounted orthogonally. For instance if the first dispersive element 1180 is a grating extending along a first direction then the echelle grating 1120 extends along a second direction substantially orthogonal to the first direction.

In operation, the first dispersive element 1180 produces a dispersed beam onto the surface of the echelle grating 1120, which in turn generates multiple spectra that includes a long wavelengths spectrum 1112, a medium wavelengths spectrum 1114, and a short wavelengths spectrum 1116. The spectra or spectral bands 1112, 1114 and 1116 are stacked on top of each other to form a so-called echellogram 1110. The three bands are imaged onto three different regions of the DMD. The first band 1112 is located on a first (top) region, the second band 1114 is located on a second (middle) region and the third band 1116 is located on a third (bottom) region.

The controller 1160 is configured to control the mirrors in the first second and third regions individually in order to shape the spectrum of each band according to a specific target spectrum. A target spectrum may be set for each individual band. For instance three different target spectra may be set for the bands 1112, 1114 and 1116, respectively. The pattern of each region of the DMD is then adjusted iteratively according to the method descried above with reference to FIGS. 2, 5, 6 and 7.

In FIG. 11 three spectra are represented, however it will be appreciated that the echellogram 1110 may be constituted of N individual spectral bands, in which N is an integer. In this case the DMD would be split into N regions, and the controller would be adapted to adjust the N regions of the DMD in parallel. The system of FIG. 11 is particularly useful for applications requiring a wide spectral range combined with a high resolution.

FIG. 12 illustrates another implementation of the system of FIG. 11 based on the design of FIG. 10. FIG. 12 shares similar components to those illustrated in FIG. 10. The same reference numerals have been used to represent corresponding components and their description will not be repeated for sake of brevity. In the system 1200, the diffraction grating 1020 has been replaced by a dispersive element 1280 (such as a grating, a prism a volume Bragg grating, a grating prism (grism), a photonic crystal or other refractive device) optically arranged with an echelle grating 1220. The dispersive elements 1280 and 1220 are mounted orthogonally. For instance if 1280 is a grating extending along a first direction then the echelle grating 1220 extends along a second direction substantially orthogonal to the first direction. Similarly, the diffraction grating 1022 has been replaced by a dispersive element 1282 arranged with another echelle grating 1222. The dispersive elements 1282 and 1222 are mounted orthogonally.

In operation, the dispersive element 1280 produces a dispersed beam onto the surface of the echelle grating 1220, which in turn generates multiple spectra 1212, 1214, 1216 stacked on top of each other to form the echellogram 1210. The three bands are imaged onto three different regions of the DMD. The controller 1260 is configured to control the mirrors in the first second and third region individually in order to shape the spectrum of each band according to a specific target spectrum.

The optical design of the embodiments described in relation to FIGS. 3,10,11, and 12 may be modified so that the light spectrum projected onto the light modulator has a desired geometrical shape. For instance, the optical device used to image the light spectrum onto the DMD may be selected to achieve a line spectrum, an oval spectrum, a circular or semi-circular spectrum.

FIG. 13 illustrates a modification of the system of FIG. 3 in which the same reference numerals have been used to represent corresponding components. In FIG. 3 the lens 320 may be a spherical lens that is used to form a line spectrum onto the DMD. In FIG. 13, the system 1300 is provided with a cylindrical lens 1320. As a result a circular or semi-circular spectrum is formed on the DMD. Such a design may be used to disperse the power of the incident light across a large number of mirrors hence allowing to shape the spectrum of a high power beam without thermally overloading the light modulator. This could have benefits, for example allowing the shaping of high power lasers. In addition, by increasing the number of mirrors being used in the shaping process, a small intensity change can be achieved by switching only one mirror one or off. This improves the dynamic range of the system.

The systems described with respect to FIGS. 3, 10, 11, 12 and 13 may be modified to use a different type of spatial light modulator. For instance, the spatial light modulator implemented as a DMD could be replaced by a liquid crystal device such as a liquid crystal on silicon (LCOS) having a 2D array of polarizing cells. The polarization of each cell is controllable to set the cell in a first state corresponding to a first polarization and a second state corresponding to a second polarization. For instance, the first and second polarization may be orthogonal, hence allowing to shape the spectrum of the beam reflected onto the liquid crystal device by controlling the polarization of the cells. In this scenario, various polarizers would be provided on the optical path of the system to control the polarization of the input light and the polarization of the light being detected by the detector. For instance in the system of FIG. 3, a first polarizer may be provided at the output of the light source 310 to define the polarization of the input beam and a second polarizer may be provided at the entrance of the spectrometer to reject ray of light having a specific polarization.

The shaping method of the disclosure may be used to shape spectra with a wide variety of target profiles. Potential spectral shapes may include among other potential profiles: parabola and inverse parabola, sawtooth modulation, ramp and inverse ramp, sinusoidal, trapezoid, flat, square and double square profiles.

FIGS. 14A to 14F show the measurements of six spectra shaped using the method according the disclosure to match different target profiles. Each figure illustrates the source spectrum 1410 obtained from an OPO source, the target spectrum 1420-1425, and the shaped spectrum 1430-1435. FIG. 14A illustrates a spectrum 1430 shaped to match a flat profile 1420 at relatively high intensity. FIG. 14B illustrates a spectrum 1431 shaped to match a double square profile 1421 in which the first and the second square have different intensities. FIG. 14C illustrates a spectrum 1432 shaped to match an inverse parabola profile 1422. FIG. 14D illustrates a spectrum 1433 shaped to match a sawtooth modulation profile 1423. FIG. 14E illustrates a spectrum 1434 shaped to match a trapezoidal profile 1424. FIG. 14F illustrates a spectrum 1435 shaped to match a ramp profile 1425.

A skilled person will appreciate that variations of the disclosed arrangements are possible without departing from the disclosure. For instance, although the system of the disclosure has been described using a spatial light modulator implemented as a DMD, it will be appreciated that the system of the disclosure may be implemented using other types of spatial light modulators including and not limited to liquid crystal light modulators. Accordingly, the above description of the specific embodiments is made by way of example only and not for the purposes of limitation. It will be clear to the skilled person that minor modifications may be made without significant changes to the operation described.

1. An apparatus for shaping a light spectrum, the apparatus comprising:
a dispersive element adapted to produce a primary beam;
a spatial light modulator comprising an array of cells, each cell being operable in a first state and a second state, for shaping the spectrum of the primary beam, wherein the second state is associated with a first logic value and the first state is associated with a second logic value;
an optical device arranged to image the primary beam onto the spatial light modulator to produce a secondary beam having a shaped spectrum;
a detector adapted to measure the shaped spectrum; and
a controller configured to change the state of a subset of cells iteratively, based on a stochastic process, to shape the spectrum;
wherein the controller is configured to perform a sequence of steps comprising:
calculating a difference between the shaped spectrum and a target spectrum to obtain a difference spectrum having a plurality of spectral elements, each spectral element being associated with a corresponding set of cells in the array,
calculating an error value and generating a list of random values for each set of cells,
changing a state of one or more cells selected based on the list of random values; and
repeating iteratively the sequence of steps to reduce the error values;
wherein the controller is configured to generate for each set of cells a corresponding set of intermediate logic values, and to calculate an adjusted set of logic values for adjusting the state of the cells; wherein the adjusted set of logic values is obtained by performing a logic operation between the set of intermediate logic values and a previous set of logic values.

2. (canceled)

3. The apparatus as claimed in claim 1, wherein each random value is assigned to a corresponding cell or group of cells.

4. The apparatus as claimed in claim 1, wherein each cell is operable in one or more additional states.

5. The apparatus as claimed in claim 1, wherein the sequence comprises changing the configuration of the array by setting a plurality of cells in the second state when the error value is positive and by setting at least one cell in the first state when the error value is negative.

6. (canceled)

7. (canceled)

8. (canceled)

9. The apparatus as claimed in claim 1, wherein when the error value is positive the controller is configured
to compare each random value with the error value to generate the set of intermediate logic values, and
to perform an AND logic operation between the set of intermediate logic values and a corresponding previous set of logic values to obtain the adjusted set of logic values.

10. The apparatus as claimed in claim 1, wherein when the error value is negative the controller is configured
to generate the set of intermediate logic values by calculating a product based on the random value and the error value, and
to perform an OR logic operation between the set of intermediate logic values and a corresponding previous set of logic values to obtain the adjusted set of logic values.

11. The apparatus as claimed in claim 1, wherein the controller is adapted to set the spatial light modulator to an initial configuration before starting the sequence, wherein the initial configuration is based on a profile of the target spectrum.

12. The apparatus as claimed in claim 1, wherein the dispersive element, the optical device, the spatial light modulator and the detector are provided along an optical path, the spatial light modulator being arranged such that the secondary beam is reflected back along the optical path towards the detector.

13. The apparatus as claimed in claim 1, comprising an additional dispersive element and an additional optical device wherein the dispersive element, the optical device, and the spatial light modulator are provided along a first optical path, and wherein the additional dispersive element, the additional optical device and the detector are provided along a second optical path the spatial light modulator being arranged such that the secondary beam is reflected along the second optical path towards the detector.

14. The apparatus as claimed in claim 1, comprising an echelle grating coupled to the dispersive element to generate a plurality of dispersed beams each beam having a corresponding spectrum forming an echellogram, and wherein the controller is configured to shape the echellogram.

15. The apparatus as claimed in claim 14, wherein each spectrum forming the echellogram is shaped to match a corresponding target spectrum.

16. The apparatus as claimed in claim 15, wherein the controller is configured to assign different regions of the array to a specific spectrum of the echellogram, and to control the cells of each region to shape a corresponding spectrum.

17. The apparatus as claimed in claim 1, wherein the cells are mirror cells, each mirror cell being individually orientable to be configured in the first state or the second state.

18. The apparatus as claimed in claim 1, wherein the cells are polarizing cells.

19. The apparatus as claimed in claim 1, wherein the optical device is adapted to project the spectrum onto the spatial light modulator to obtain a projected spectrum having a circular or semi-circular shape.

20. A system comprising an apparatus as claimed in claim 1, coupled to a light source.

21. The system as claimed in claim 20, wherein the light source comprises at least one of a laser source, a thermal emitter, a fluorescence source and an amplified spontaneous emission source.

22. The system as claimed in claim 21, wherein the laser source comprises at least one of an ultrafast laser, an ultrafast optical parametric oscillator, and a laser supercontinuum.

23. A method for shaping a light spectrum, the method comprising:
producing a primary beam using a dispersive element;
providing a spatial light modulator having an array of cells, each cell being operable in a first state and a second state, for shaping the spectrum of the primary beam, wherein the second state is associated with a first logic value and the first state is associated with a second logic value;
imaging the primary beam onto the spatial light modulator to produce a secondary beam having a shaped spectrum;
measuring the shaped spectrum using a detector; and
changing the state of a subset of cells iteratively, based on a stochastic process, to shape the spectrum by performing a sequence of steps comprising:
calculating a difference between the shaped spectrum and a target spectrum to obtain a difference spectrum having a plurality of spectral elements, each spectral element being associated with a corresponding set of cells in the array;
calculating an error value and generating a list of random values for each set of cells,
changing a state of one or more cells selected based on the list of random values; and
repeating iteratively the sequence of steps to reduce the error values;
wherein the method further comprises generating for each set of cells a corresponding set of intermediate logic values, and calculating an adjusted set of logic values for adjusting the state of the cells; wherein the adjusted set of logic values is obtained by performing a logic operation between the set of intermediate logic values and a previous set of logic values.

24. (canceled)
